(19) United States
(12) Patent Application Publication
(10) Pub. No.: US 2025/0296646 A1
(43) Pub. Date: Sep. 25, 2025

(54) Wireless dropper post actuator system

(71) Applicant: Paul Gallagher, SIOUX FALLS, SD (US)

(72) Inventor: Paul David Gallagher, Burkesville, KY (US)

(73) Assignee: Paul Gallagher, SIOUX FALLS, SD (US)

(21) Appl. No.: 18/614,778

(22) Filed: Mar. 25, 2024

(51) Int. Cl. B62J 1/08; B62J 43/30; B62J 45/20

(52) U.S. Cl. CPC B62J 1/08; B62J 43/30; B62J 45/20; B62J 2001/085

(57) ABSTRACT

This invention relates to a wireless dropper post actuator system for bicycles, with a wireless functionality, thereby simplifying installation and enhancing usability. The system comprises a compact, lightweight linear actuator motor, integrated with a battery, microprocessor, and circuit board. Facilitating wireless height adjustment through signals, this novel system eliminates the need for internal cable routing, addressing common installation challenges and reducing maintenance. Additionally, the system includes an integrated charging solution, supports programmable position adjustments, and is adaptable for both traditional and electric bicycles through wireless and wired configurations, respectively. Employing a proprietary NXS wireless network, the system enhances connectivity and control, setting a new standard for dropper post actuation technology.

### BACKGROUND OF THE INVENTION

In the rapidly evolving field of bicycle technology, dropper posts have emerged as a standard feature for modern mountain and trail bikes, offering riders the ability to adjust saddle height on the fly, much like the mechanism of a gas-charged office chair. These devices typically rely on a mechanical actuator operated by a cable, which is connected to a lever on the handlebar. While effective, this cable-actuated system presents notable challenges, especially regarding the complexity of installation and maintenance. The internal routing of cables through the bicycle frame, a common practice to maintain aesthetics and reduce exposure to elements, often proves to be labor-intensive and requires specialized tools, particularly in an OEM environment. Moreover, recent advancements have introduced wireless dropper posts to the market, promising to alleviate these installation woes. However, such solutions come at a significant cost, placing them out of reach for many consumers and maintaining a barrier to widespread adoption. The present invention represents a simplification of the currently available wireless droppers, making it much more economical.

### SUMMARY OF THE INVENTION

Addressing the limitations of current dropper post technologies, this invention introduces a revolutionary wireless dropper post actuator system, designed to seamlessly integrate into existing dropper post designs. Central to this system is a compact and lightweight linear actuator motor, complemented by an integrated battery, microprocessor, and circuit board. This configuration is engineered to replace the conventional mechanical actuator, facilitating height adjustment via wireless signals and obviating the need for cumbersome cable routing. Dimensions are meticulously optimized to ensure compatibility across a diverse range of bicycles, with the entire unit boasting an outer diameter of less than 34 mm, a length of less than 45 mm, and a total weight of under 70 grams. Furthermore, the system incorporates an integrated charger for enhanced maintenance ease, alongside programmable position adjustment capabilities for precise control. Significantly, it introduces the flexibility to operate in both wireless and wired configurations, the latter catering specifically to the burgeoning e-bike market. By leveraging a proprietary NXS wireless network, the present invention sets a new standard in dropper post technology, offering an affordable, user-friendly solution that promises widespread accessibility and adoption.

### BRIEF DESCRIPTION OF THE DRAWINGS

FIG. 1 is an external view of the dropper post and motor actuator, separated for clarity. Dropper post lower tube (1), Motor actuator housing (2), Antenna connector (5), Retainer clip (7), Coaxial cable (8), Hydraulic release plunger (9), Fixing screw (3), Manual override (12), Charging port (13).

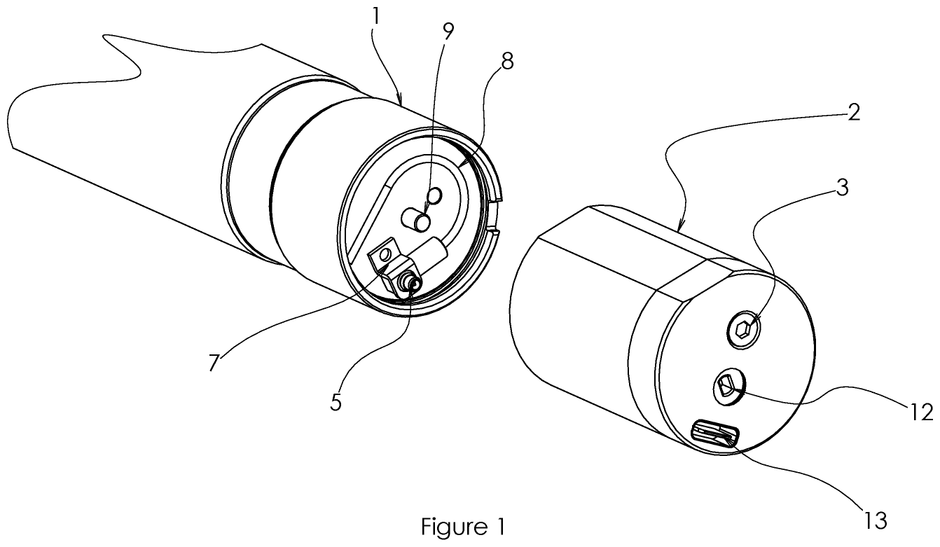

FIG. 2 is an external view of the dropper post and motor actuator, separated for clarity. Dropper post lower tube (1), Motor actuator housing (2), Mounting Screw (3), Actuator plunger (4), Antenna connector (6).

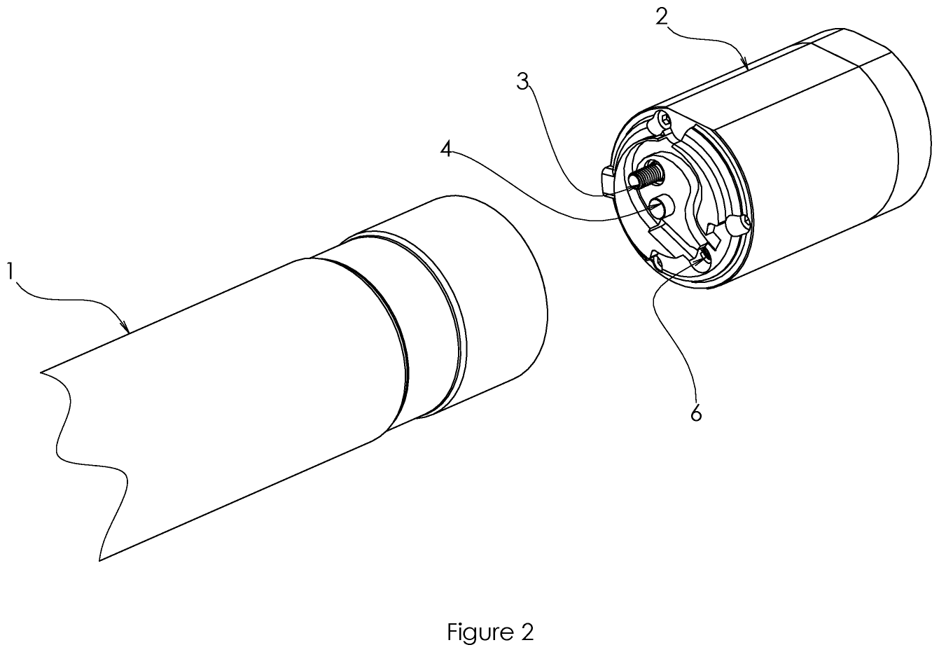

FIG. 3 is a cutaway view of the top half of the lower tube. Lower tube (1), Antenna module (16)

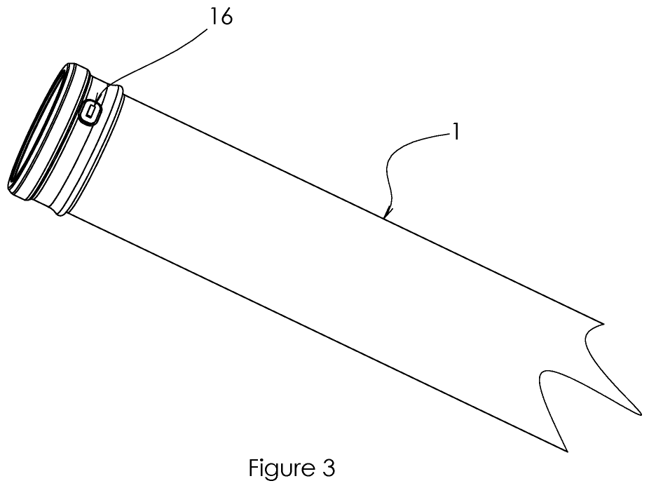

FIG. 4 is an internal view of the dropper post lower tube. Lower tube (1), Guide grooves (14), antenna cable groove (15).

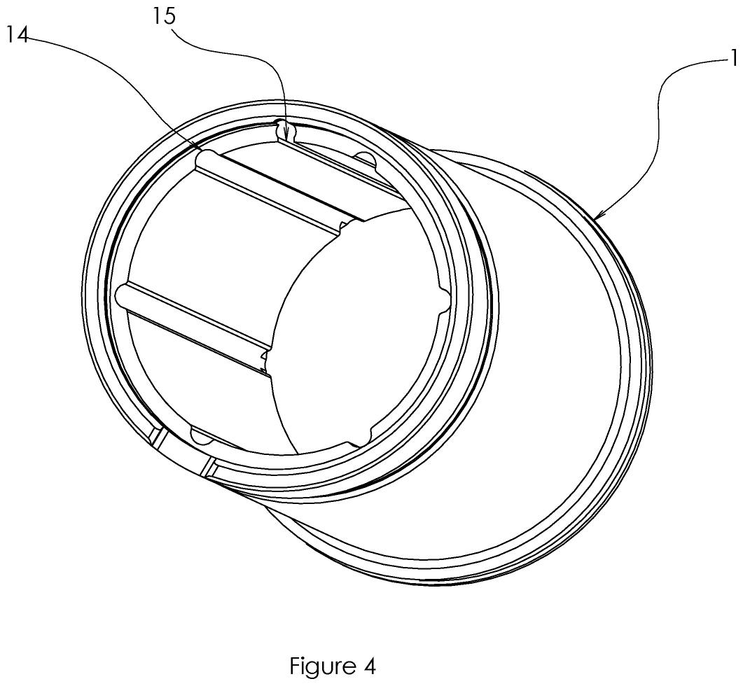

FIG. 5 is an internal view of the motor actuator assembly with the housing and battery removed for clarity. Actuator plunger (4), Antenna connector (5), Charging port (13), DC motor (17), Linear actuator nut (18), Motor gear (19), Screw gear (20), PCB assembly (21), Linear actuator screw (22)

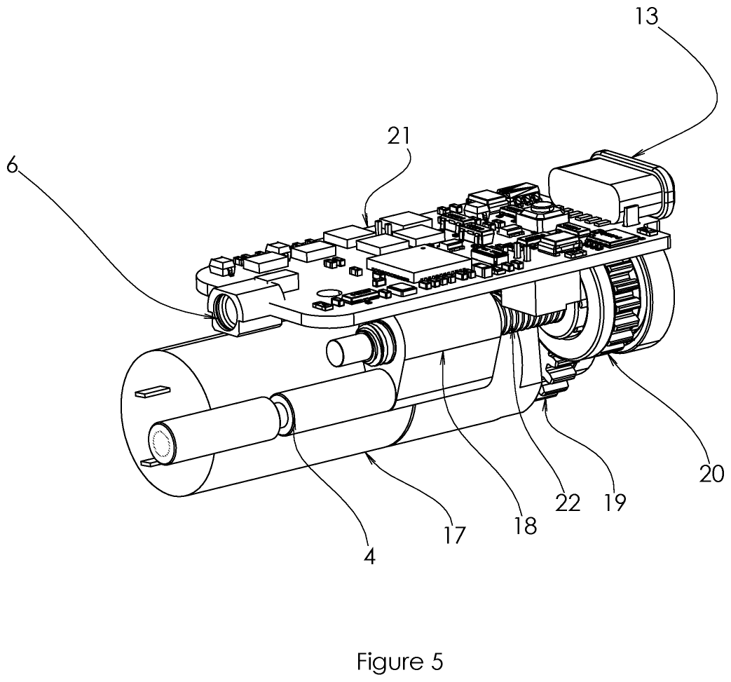

### DETAILED DESCRIPTION OF THE DRAWINGS AND OPERATION

The device comprises a dropper lower tube (1), which is inserted into the bicycle frame. The actuator housing (2) features a molded plastic enclosure complemented by an aluminum end cap, housing all necessary electronic and mechanical components for operation. A fixing screw (3) secures the actuator assembly to the dropper post, while the actuator plunger (4) interfaces with the dropper post's hydraulic release plunger (9).

Connectivity is facilitated by an antenna connector (5), which attaches to a corresponding connector (6) via a MMCX-style connection, allowing for axial engagement. The design does not limit to a specific connector model but emphasizes the mechanism of engagement. A retaining clip (7) ensures the antenna connector remains securely positioned for reliable connectivity. The antenna cable (8) extends from connector (5), running through a groove (15) in tube (1), and connects to the antenna module (16), compatible with various antenna types including chip, PCB trace, or other suitable antennas.

A manual override (12) provides an alternative operation mode in cases of device jamming, battery failure, or other malfunctions. This feature enables manual adjustment of the plunger to control the hydraulic valve within the dropper post. Additionally, a charging port (13) is incorporated for recharging the actuator's onboard battery.

### Actuator Operation:

The actuator operation begins when the PCB (21) receives a Bluetooth signal through connector (6). This signal is processed by the onboard microprocessor, which activates the DC motor (17). The motor engages the motor gear (19), which in turn interacts with the screw gear (20), causing the attached screw (22) to rotate. This rotation moves the actuator nut (18), which then adjusts the position of the plunger (4). Consequently, the plunger (4) actuates the dropper post's hydraulic release plunger (9), facilitating height adjustment.

### System Components

The actuator system comprises several key components integrated into a compact and efficient assembly:
Linear Actuator Motor: Serves as the primary mechanism for actuating the dropper post, replacing the need for a mechanical cable and lever system. The motor is capable of exerting sufficient force to unlock the dropper post, allowing for height adjustment.
Battery: Powers the linear actuator motor and the system's electronics. It is rechargeable, ensuring continuous operation and easy maintenance.
Microprocessor: Acts as the control center of the system, processing wireless signals and managing the operation of the linear actuator motor based on inputs from the user.
Circuit Board: Houses the microprocessor and provides the necessary circuitry for integrating the system's components. It also includes connectivity options for the antenna.
Antenna: Facilitates wireless communication with an external control device, such as a handlebar-mounted remote. The system can include both an external wire antenna for enhanced reception and an integrated antenna on the circuit board for compactness.

### Charging and Maintenance

The integrated charger facilitates easy recharging of the battery, ensuring that the system is always ready for use. The compact design of the actuator system, with dimensions ensuring an outer diameter of less than 34 mm and a length of less than 45 mm, and a weight of under 70 grams, makes it unobtrusive and minimally impactful on the bike's aesthetics and performance.

### CONCLUSION

The actuator system represents a significant advancement in dropper post technology, offering a wireless, easily installed, and user-friendly solution. By eliminating the complexities associated with cable routing and providing a cost-effective alternative to existing wireless dropper posts, the actuator system is poised to become an essential upgrade for cycling enthusiasts seeking to enhance their riding experience.

1-11. (canceled)

12. A wireless actuator system for bicycle dropper posts, comprising:
a linear actuator motor designed to replace traditional mechanical actuators in dropper posts, capable of adjusting the dropper post height;
a battery supplying power to the linear actuator motor;
a microprocessor programmed to control the linear actuator motor in response to wireless signals;
a signal transceiver component for receiving wireless signals and communicating with the microprocessor to initiate the linear actuator motor's operation;
a circuit board integrating the microprocessor and signal transceiver component, orchestrating the reception of wireless signals and subsequent dropper post actuation;
an actuator rod mounted on the dropper post, engaging a hydraulic valve for height adjustment;
an external antenna for receiving wireless signals, connected via a cable routed through the dropper post's outer tube.

13. The system of claim 12, including an integrated charger within the actuator system for battery recharging, promoting easy maintenance and continuous dropper post operation.

14. The system of claim 12, featuring an axially engaged socket and plug for the antenna connection.

15. The system of claim 14, including an integrated charger within the actuator system for battery recharging, promoting easy maintenance and continuous dropper post operation.

16. The system of claim 12, wherein the antenna cable serves a dual function, also used to charge the battery within the motor unit.

17. The system of claim 12, characterized by dimensions with an outer diameter less than 34 mm and a length less than 45 mm, measured from the existing post's end, and a total weight under 70 grams, ensuring the system's compactness and lightweight design.

18. The system of claim 12, wherein the linear actuator motor is precisely configured to engage an unlock button on the dropper post, emulating the function of a traditional mechanical lever and cable through a wireless solution.

19. The system of claim 12, incorporating a screw and nut configuration within the linear actuator for precise actuation.

20. The system of claim 12, employing a cam mechanism to engage the dropper post's unlock button, providing an alternative actuation method.

21. The system of claim 12, featuring an antenna integrated onto the circuit board, enabling efficient signal communication.

22. The system of claim 12, including programmable position adjustment capabilities for precise control over the dropper post valve's open and close points, ensuring optimal efficiency.

23. The system of claim 12, adaptable for a wired configuration in electric bicycles (e-bikes), where the system is powered directly by the e-bike's battery, further including a connection interface for integration with the e-bike's electrical system and a control module to receive power and control signals through the wired connection, enabling dropper post actuation via electronic signals from the e-bike's control system.
